(19) United States
(12) Patent Application Publication
(10) Pub. No.: US 2018/0269681 A1
(43) Pub. Date: Sep. 20, 2018

(54) POWER SYSTEMS AND RELATED VOLTAGE STABILITY METHODS

(71) Applicant: V & R Energy Systems Research, Inc., Los Angeles, CA (US)

(72) Inventors: Michael Vaiman, Los Angeles, CA (US); Marianna Vaiman, Los Angeles, CA (US)

(73) Assignee: V & R Energy Systems Research, Inc., Los Angeles, CA (US)

(21) Appl. No.: 15/458,895

(22) Filed: Mar. 14, 2017

(51) Int. Cl. H02J 3/16; G05B 15/02

(52) U.S. Cl. CPC H02J 3/16; G05B 15/02

(57) ABSTRACT

For a power-system configuration, correspondence between a phase-angle, alone or combined with a voltage magnitude, representative of an operational state of the power-system configuration and a proximity to voltage-collapse for the power-system configuration can be provided. A proximity to voltage-collapse for the power-system configuration can be determined based at least in part on an observation of the phase-angle and the correspondence between the phase-angle and the proximity to voltage-collapse for the power-system configuration. A remedial action contemplated to maintain voltage-stable operation of the power-system configuration can be taken responsive to the proximity to voltage-collapse for the power-system configuration falling below a selected threshold proximity. Systems, apparatus, and methods embodying such innovative principles can be used to plan, to design, and/or to operate voltage-stable power systems.

### BACKGROUND

Maintaining steady-state voltage stability over a wide variety of operational states and system stresses constitutes one of the most pressing issues facing electric utilities responsible for managing and operating power systems. This application, and the innovations and related subject matter disclosed herein, (collectively referred to as the “disclosure”) generally concern systems, apparatus, and methods for providing voltage-stable electric-power transmission systems (generally referred to in the art as “power systems”). More particularly but not exclusively, some disclosed systems, apparatus, methods, and associated principles pertain to planning, designing, assessing, operating, and/or controlling power systems to achieve steady-state voltage stability throughout such systems, or branches thereof. According to some aspects of disclosed discoveries, phase-angle, voltage, or both, can constitute reliable indicia of power-system stress (e.g., real power, reactive power), and/or available remaining margin before the power system becomes unstable or voltage collapse occurs. More specifically, a level, or measure, of stress, at which collapse occurs can correlate well to one or both of voltage magnitude and phase-angle. Based in part on that discovery and presently disclosed principles, power-systems planners, designers, and operators will be able to assess voltage magnitude and/or phase-angle to determine whether or to what extent remedial action might be warranted during planning, design, or operation, respectively, to mitigate or altogether avoid voltage instability or voltage collapse. Power system stressing parameters can include, but are not limited to any combination of real and reactive power, such as, for example, real and/or reactive components of load, generator power output, and/or power transfer through an interface, and/or a contingency.

By way of introduction, in a simple alternating current (AC) circuit consisting of a source and a linear load, both the current and voltage can vary sinusoidally. If the load is purely resistive, the current and the voltage reverse their polarity at the same time. Whenever the instantaneous product of voltage and current is positive, energy flows from source to load and so-called active (or real) power is transferred.

On the other hand, if the load is purely reactive, then the voltage and current will be 90 degrees out of phase. In such a situation, the product of voltage and current will be positive over two quarters of each cycle and the product will be negative on the other two quarters of each cycle. Thus, on average over a complete cycle (or one-half cycle), as much energy will flow toward the load as will flow back to the generator and no net energy will flow from the generator to the load. Stated differently, there will be no net transfer of energy to the load. Nonetheless, electrical power does flow to the load and return from the load over the same wire (or transmission line). Such power flow is referred to in the art as “reactive power,” and results in losses due to line resistance.

Most practical loads have a measure of resistance, inductance, and capacitance. Consequently, for most practical loads, active and reactive power will flow to real loads. Power engineers often define apparent power as a magnitude of the vector sum of active power, P, and reactive power, Q. Thus, apparent power, S, equals the magnitude of (P²+Q²)^{1/2}.

The so-called “power factor” of a given power system refers to a ratio of active, or real, power to apparent power. Consequently, the power factor of a power system equals the cosine of the phase-shift, or phase angle. δ, between voltage and current in the power system.

Electrical engineers account for reactive power when designing and operating power systems, because though the current associated with reactive power does no work at the load, reactive power heats conductors and results in energy losses. Accordingly, transmission lines and other conductors, transformers and generators generally are designed to carry the total current rather than just current that does useful work at a given load. Providing an inadequate supply of reactive power over a power system, or branch thereof, (sometimes referred to as an “electrical grid”) can lead to a reduction in voltage, either over a transmission line or at one or more selected loads. Under some operating conditions, voltage can uncontrollably fall, or collapse, over a portion of or an entire power system, resulting in a so-called “blackout.”

As used herein, the term “voltage stability” means a measure of the ability of a given power system to maintain steady voltages throughout the system, or within a branch thereof, after the system, or branch, is subjected to a disturbance (e.g., a fault, an increase in load demand, a reduction in generation, or another change in system state) from an initial state of operation. The voltage is said to become unstable, or to collapse, when the disturbance (sometimes also referred to in the art as a “contingency”) results in an uncontrolled and continuous reduction in voltage throughout the system or a branch thereof. Some voltage stability problems can start as a local problem within a branch and escalate, or cascade, to a problem throughout the system.

As well, mathematical models describing power system behavior have become complex. For example, an average planning case modeling the Eastern Interconnection of the United States can have between about 60,000 and about 80,000 buses, and power-system models can consider, among other things, reactive power limits of generators, as well as continuous and discrete controls. Operational studies using node-breaker models can be even more complex. For example, some models used by Peak Reliability in performing real-time or near real-time case studies can contain between about 17,000 and about 18,000 buses, or approximately 100,000 nodes. Moreover, millions of contingencies (or changes to power-system configuration) can be assessed within one simulation. Such contingency simulations can provide estimates of physical (e.g., thermal and voltage constraints) and operational (e.g., voltage stability) margin.

Steady-state operation of a power system model can be modeled by a set of algebraic equations. A common numerical method used to solve large systems of algebraic equations, the so-called Newton method, and variations thereof, can be used to assess an upper threshold measure (sometimes referred to in the art as “a level”) of stress at which voltage collapse occurs for a given power system configuration. Beyond that level, the Newton method diverges or jumps from a vicinity of one equilibrium point to a vicinity of another equilibrium point without converging to a given equilibrium. In either event, the non-convergence of the Newton method indicates that the set of algebraic equations are incompatible and lack a solution under a normal or the disturbed state, or contingency, being simulated.

Conventionally, voltage stability of a power system, and the available margin before voltage collapse, has been determined from observations of variation in voltage, V, with real power and variation in voltage with reactive power. Many conventional approaches for assessing voltage stability and stability margin involve observations of PV-curves and QV-curves, as generally depicted in FIG. 1, or a surface, V(P,Q), defining variation of voltage with real power and reactive power in V-P-Q space, as in FIG. 7. In recent years, however, it has become clear that such observations do not adequately predict voltage collapse under certain conditions. For example, as shown in FIG. 1, voltage 100 can remain substantially constant over a wide range of real power, and can suddenly collapse 102 following a relatively small change in system stress. Such behavior can be frequently observed in “stiff” systems having a deficit of real power and/or surplus of reactive power. In FIG. 1, an upper-threshold power 106 is chosen to provide a margin of safety 108 below the power 104 at which voltage collapses.

Thus, a need remains for systems, apparatus, and methods to monitor, to assess, to detect, to predict, to maintain, and/or to control voltage stability. Further need remains for systems, apparatus, and methods to monitor, to assess, to detect, to predict, to limit, and/or to control the onset of voltage instability and/or voltage collapse. As well, a need remains for computationally efficient measures or indicators of voltage stability, stability margin, and/or instability.

### SUMMARY

The innovations and discoveries disclosed herein overcome many problems in the prior art and address one or more of the aforementioned or other needs. In some respects, the innovations disclosed herein generally concern systems, apparatus, and methods for providing voltage-stable power systems and associated techniques for assessing, maintaining and/or controlling steady-state voltage stability of power systems. More particularly, but not exclusively, disclosed principles include newly discovered measures or indices of voltage stability correlated to system stress and available operating margin. Such principles allow power-system planners, designers, and operators to assess, to maintain, and/or to regain voltage-stable operation of a power system. As but one example, phase-angle, δ, was discovered to vary in correspondence with power-system stress and to indicate available operating margin. Some disclosed systems, apparatus, and methods incorporate phase-angle predictions, observations and/or measurements to gage voltage stability and available operational margin during planning, design, and/or operation of power systems. Some embodiments of disclosed, innovative principles allow planners, designers, and/or operators to adjust a power-system configuration to maintain voltage stability despite loads or stresses exceeding a selected upper threshold load or stress.

In some instances, the upper threshold measure of stress can correspond to a set of operating conditions (e.g., system stresses) beyond which voltage collapse or other uncontrollable change in system operating state would occur, but-for an adjustment to the power-system configuration. In other instances, the upper threshold measure of stress, or load, can correspond to a set of operating conditions having a selected degree of operational margin, beyond which margin voltage collapse or other uncontrollable change in system operating state would occur unless the power-system configuration is adjusted. Some disclosed systems and techniques are suitable for one or more of planning a power system, or branch thereof, designing such a system or branch, and maintaining voltage-stable operation of such a system or branch.

Methods for providing a voltage-stable power system are disclosed. For a power-system configuration, correspondence between a phase-angle representative of an operational state of the power-system configuration and voltage magnitude representative of an operational state of power-system configuration can be provided. For a power-system configuration, voltage magnitude representative can experience uncontrollable decline and phase-angle representative (or phase angle differences) can experience uncontrollable change at the same value of the stressing parameter. For a power-system configuration, voltage magnitude representative and phase-angle representative can be equal indicators of power system voltage stability. Phase-angle representative and voltage representative can be computed using the power flow equations for the power-system configuration or measured by phasor measurement units (PMUs). For a power-system configuration, correspondence between a phase-angle representative of an operational state of the power-system configuration and a proximity to voltage-collapse for the power-system configuration can be provided. A proximity to voltage-collapse can be determined for the power-system configuration based at least in part on an observation of the phase-angle and the correspondence between the phase-angle and the proximity to voltage-collapse for the power-system configuration. Responsive to the proximity to voltage-collapse for the power-system configuration falling below a selected threshold proximity, a remedial action contemplated to maintain voltage-stable operation of the power-system configuration can be taken.

In some embodiments, the act of taking a remedial action contemplated to maintain voltage-stable operation of the power-system configuration can include one or more of the following:

adjusting the power-system configuration to change generator real-power output;

adjusting the power-system configuration to change generator reactive-power output;

adjusting the power-system configuration to curtail one or more loads;

adjusting the power-system configuration to reposition, to include, and/or to exclude one or more capacitors, reactors, phase-shifters, transformer taps, and/or transmission lines; and

adjusting the power-system configuration to implement a Remedial Action Scheme.

In some embodiments, the act of providing correspondence between the phase-angle representative of an operational state of the power-system configuration and the proximity of voltage-collapse for the power-system configuration can include providing phase-angle variation with real power at one or more values of reactive power, providing phase-angle variation with reactive power at one or more values of real power, or both.

The act of providing correspondence between the phase-angle representative of an operational state of the power-system configuration and the proximity to voltage collapse for the power-system configuration can include providing phase-angle variation with real power and reactive power in a three-dimensional space.

A correspondence between voltage magnitude representative of an operational state of the power-system configuration and a proximity to voltage collapse can be provided. The act of determining a proximity to voltage collapse can further be based at least in part on an observation of voltage magnitude and the correspondence between the voltage magnitude and proximity to voltage collapse.

The act of determining a proximity to voltage collapse can include determining which of voltage-magnitude variation with real power and phase-angle variation with real power has a steeper slope.

The act of providing correspondence between the voltage magnitude representative of an operational state of the power-system configuration and the proximity of voltage-collapse for the power-system configuration can include providing voltage-magnitude variation with real power at one or more values of reactive power, providing voltage-magnitude variation with reactive power at one or more values of real power, or both. The act of determining a proximity to voltage collapse based at least in part on an observation of voltage magnitude can occur concurrently (or substantially concurrently) with the act of determining a proximity to voltage collapse based at least in part on an observation of phase-angle.

The act of providing correspondence between the voltage magnitude representative of an operational state of the power-system configuration and the proximity to voltage collapse for the power-system configuration can include determining voltage-magnitude variation with real power and reactive power in a three-dimensional space.

The act of providing correspondence between the phase-angle representative of an operational state of the power-system configuration and the proximity to voltage collapse for the power-system configuration can include providing phase-angle variation with real power and reactive power in a three-dimensional space.

The act of determining a proximity to voltage collapse based at least in part on an observation of voltage magnitude can occur concurrently (or substantially concurrently) with the act of determining a proximity to voltage collapse based at least in part on an observation of phase-angle.

The act of taking a remedial action can include adjusting the power-system configuration. In such instances, disclosed methods can also include providing correspondence between a phase-angle representative of an operational state of the adjusted power-system configuration and a proximity to voltage collapse for the adjusted power-system configuration. A proximity to voltage collapse can be determined for the adjusted power-system configuration based at least in part on an observation of the phase-angle and the provided correspondence between the phase-angle and the proximity to voltage collapse for the adjusted power-system configuration.

The selected threshold proximity can be a first threshold proximity and the remedial action can include a first remedial action. Some disclosed methods further include taking a second remedial action contemplated to maintain voltage-stable operation of the adjusted power-system configuration responsive to the proximity to voltage collapse for the adjusted power-system configuration falling below a selected second threshold proximity.

Other aspects of methods for providing a voltage-stable power system are disclosed. Correspondence between a phase-angle representative of an operational state of a power-system configuration and a proximity to voltage-collapse for the power-system configuration can be provided. A proximity to voltage-collapse can be determined for the power-system configuration based at least in part on an observation of the phase-angle and the correspondence between the phase-angle and the proximity to voltage-collapse for the power-system configuration. Responsive to the proximity to voltage-collapse for the power-system configuration falling below a selected threshold proximity, a remedial action contemplated to maintain voltage-stable operation of the power-system configuration can be taken.

Also disclosed are tangible, non-transitory computer-readable media including computer executable instructions that, when executed, cause a computing environment to implement one or more methods disclosed herein. Digital signal processors (DSPs) suitable for implementing such instructions are also disclosed. Such DSPs can be implemented in software, firmware, or hardware.

The foregoing and other features and advantages will become more apparent from the following detailed description, which proceeds with reference to the accompanying drawings.

### BRIEF DESCRIPTION OF THE DRAWINGS

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation.

FIG. 1 shows a plot of voltage variation with real power (referred to herein as a PV-curve) for a given power-system configuration. In FIG. 1, the so-called PV-curve shows little variation of voltage over a wide-range of real power, until the voltage collapses at an upper-threshold power, P_{collapse}.

FIG. 2 shows a plot of a PV-curve for a selected bus in a 4911-bus system. FIG. 2 also includes a plot of phase-angle variation with real power (referred to herein as a Pδ-curve) for the same bus.

FIG. 3 schematically illustrates a four-bus power system.

FIG. 4 shows a plot of a PV-curve and a plot of a Pδ-curve for a 4-bus system of the type shown in FIG. 3.

FIG. 5 shows several plots of PV-curves and Pδ-curves for different values of reactance for branch 3-4 in the system depicted in FIG. 3.

FIG. 6 shows several plots of PV-curves and Pδ-curves for different values of admittance for shunt 3 in the system depicted in FIG. 3.

FIG. 7 shows a surface plot of voltage variation with real power and reactive power (referred to herein as a V(P,Q)-surface) for a first bus in a selected 9013-bus system.

FIG. 8 shows a surface plot of phase-angle variation with real power and reactive power (referred to herein as a δ(P,Q)-surface) for the bus as in FIG. 7.

FIG. 9 shows a V(P,Q)-surface for a second bus in the 9013-bus system associated with FIG. 7.

FIG. 10 shows a δ(P,Q)-surface for the same bus as in FIG. 9.

FIG. 11 shows a V(P,Q)-surface for a third bus in the 9013-bus system associated with FIG. 7.

FIG. 12 shows a δ(P,Q)-surface for the same bus as in FIG. 11.

FIG. 13 shows examples of increased voltage-stability margin achieved from taking remedial action under at least two different operational states of a given power-system configuration.

FIG. 14 depicts a block-diagram of innovative methods for designing, planning, and/or operating a voltage-stable power system configuration.

FIG. 15 illustrates a block diagram of a computing environment as disclosed herein.

### DETAILED DESCRIPTION

The following describes various innovative principles related to power systems, as well as to design and management of such systems, by way of reference to specific embodiments. For example, certain aspects of disclosed subject matter pertain to systems and techniques for planning, designing and/or operating voltage-stable power systems. Embodiments of systems, apparatus, and methods described herein are but particular examples of contemplated systems, apparatus, and methods and are chosen as being convenient illustrative examples of disclosed principles. Nonetheless, or more of the disclosed principles can be incorporated in various other systems, apparatus, and methods to achieve any of a variety of corresponding system characteristics.

Thus, systems, apparatus, and methods having attributes that are different from those specific examples discussed herein can embody one or more presently disclosed innovative principles, and can be used in applications not described herein in detail. Accordingly, such alternative embodiments can also fall within the scope of this disclosure.

### I. Overview

As applicants discovered, voltage magnitude and phase angle can experience uncontrollable change at the same or substantially identical level of system stress. Further, voltage magnitude and phase angle can be equal indicators of system stress. In connection with disclosed methods, observed or computed phase angle can, alone or in conjunction with observed or computed voltage, indicate a proximity to an onset of voltage instability or voltage collapse. Phase-angle, voltage magnitude, or both, can be computed using power flow equations for the power-system configuration or measured by phasor measurement units (PMUs).

For a given power-system configuration, a phase-angle representative of an operational state of the power-system configuration can correspond to a measure of stress on the power-system configuration. In turn, a degree of stress on the power-system configuration can be determined based at least in part on an observation of the phase-angle and the correspondence between phase-angle and stress. Remedial actions can be taken if the degree of stress on the power-system configuration exceeds a threshold stress. Systems, apparatus, and methods embodying such innovative principles can be used to plan, to design, and/or to operate voltage-stable power systems.

In contrast to prior proposals for addressing voltage-stability problems, some presently disclosed techniques combine information gleaned from PV-curves and/or QV-curves with an information obtained from phase-angle variation as one combined voltage-stability criterion during stressing of a given power-system configuration. Power system stressing parameters can include any combination of real and reactive power, such as, for example, real and/or reactive components of load, generator power output, and/or power transfer through an interface. Voltage and phase angles, on the other hand, constitute state variables representative of a condition of a power-system configuration.

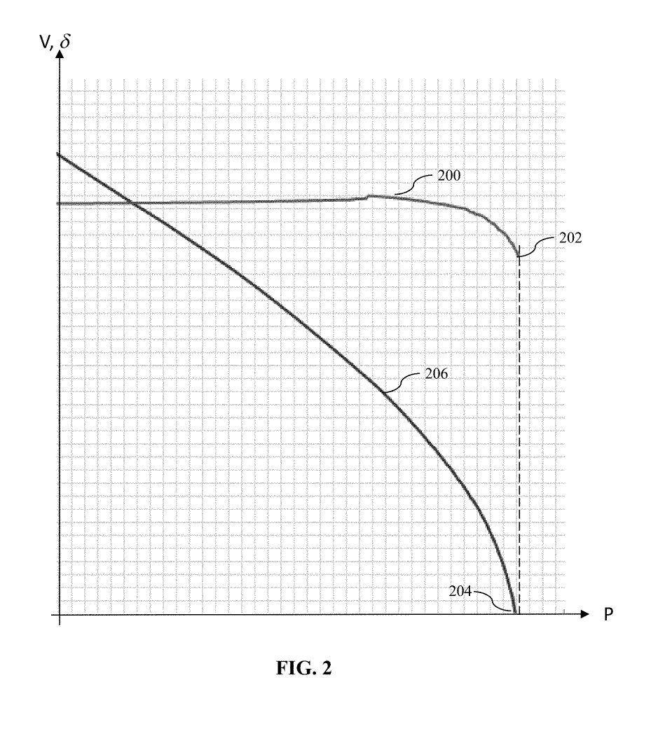

Referring now to FIG. 2, a PV-curve 200 and a Pδ-curve 206 is shown for increasing stressing parameter, e.g., real power, P, to an upper-threshold real power, P_{collapse}, 204, at which point the power system becomes unstable (e.g., voltage collapses). Nonetheless, the PV-curve 200 remains generally flat over a wide range of real power, and begins to taper off with increasing real power until voltage collapse occurs at a terminal end 202 of the PV-curve, indicating the stressing parameter at which voltage collapse occurs. In contrast to the relatively constant PV-curve 200, the Pδ-curve 206 has a negative slope, with only a slight negative curvature, through the range of real power, P, over which the PV-curve remains substantially constant.

In case of voltage instability some equations describing a flow of real and/or reactive power, and therefore the system of algebraic equations, become incompatible with each other. Power flow equations that become incompatible with each other indicate an onset of voltage instability or voltage collapse, e.g., where voltages experience uncontrollable decline and angles (or angle differences) experience uncontrollable change. Applicants discovered that uncontrollable change in phase angle occurs at the same value of the stressing parameter 202, 204, where P=P_{collapse}, as voltage collapse occurs. Since, as disclosed here, the uncontrollable change in state variables, voltages and angles, occurs at the same value of the stressing parameter 202, 204, voltage instability can be monitored or assessed based on observed or computed variation of phase angle (or phase-angle differences), voltages, or both.

Moreover, a curve with non-zero slope, such as Pδ-curve 206, provides more information in relation to a voltage stability analysis than a curve having a shallow, e.g., a substantially zero, slope, as with the PV-curve 200. For example, correspondence between phase-angle variation and system stressing parameter value shown by the curve 206 can provide a system planner, designer, or operator information to assess a degree of operating margin between a given measure of system stress, P, and the upper threshold of stressing parameter (e.g., power) associated with a voltage collapse point 204. In contrast, conventional PV-curves such as curve 200 cannot provide similar information because voltage remains substantially constant over a wide range of stressing parameter, P.

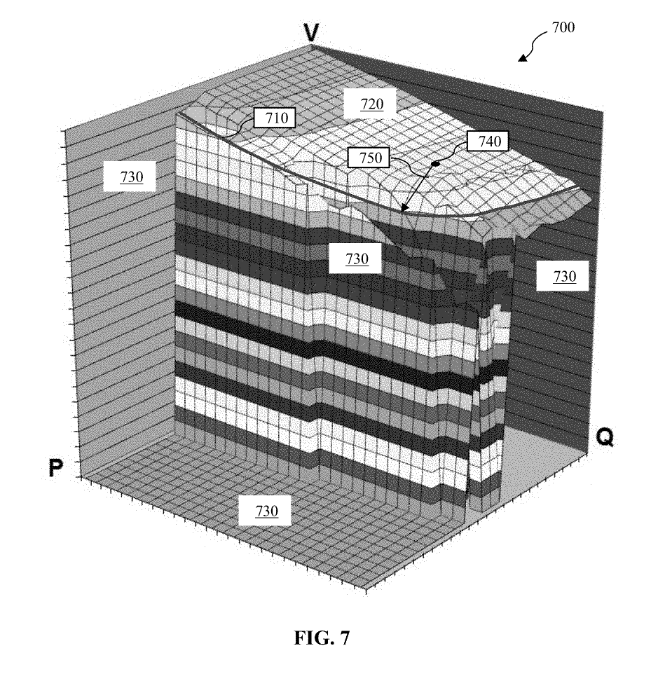

Referring momentarily to FIG. 7, variation of voltage with stressing parameters real power, P, and reactive power, Q, is shown with a V(P,Q)-surface 700. A curve 710 depicts a boundary between a region of stability 720 in V-P-Q space and a region of instability 730 in V-P-Q space. Because voltage, V, does not vary substantially throughout the region of stability 720, the V(P,Q) surface provides little information regarding a degree or measure of operating margin 750 between an operating point 740 and the stability/instability boundary 710.

PV-curves and QV-curves are sections of the surface V(P,Q) in three-dimensional (VPQ) space. To be able to solve these and wide variety of similar tasks, it is proposed to incorporate phase angle variation in steady-state stability criterion. This approach includes analysis of surface δ(P,Q), where δ is phase angle, in addition to analysis of surface V(P,Q).

As indicated by the δ(P,Q)-surface shown in FIG. 8, the value of phase-angle changes in correspondence with changes in both stressing parameters real power, P, and reactive power, Q. Thus, like the Pδ-curve shown in FIG. 2, the δ(P,Q)-surface shown in FIG. 8 can provide a measure of operating margin relative to the boundary 710 shown in FIG. 7, since phase-angle and voltage experience uncontrollable changes at the same combinations of stressing parameter values P and Q.

### II. Pδ-CURVE ANALYSIS

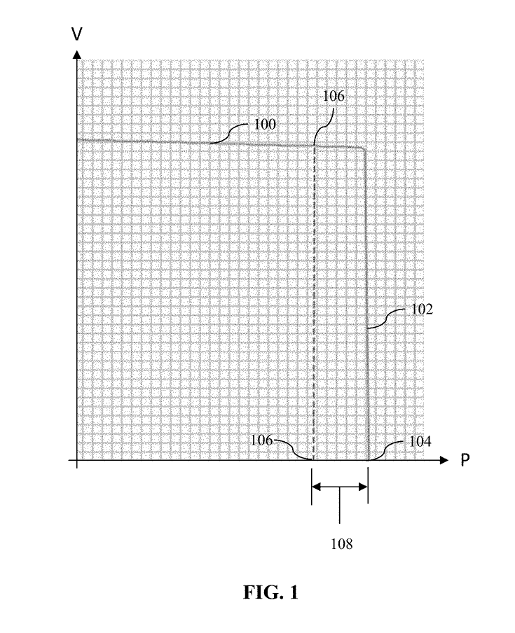

As noted above, PV-curve analysis does not yield useful results under certain conditions, e.g., where voltage varies only insignificantly with stressing parameter. Consequently, substantially constant voltage can be followed by an uncontrollable decline in voltage (voltage collapse), apparently without warning, as indicated in FIG. 1.

Research done by V&R Energy Systems Research, Inc. shows that in some cases the transmission system starts to exhibit changes only at point Pₗᵢₘ 106 which would eventually lead to voltage collapse at point P_{col1apse} 104, though such changes are not observable on the plane (P, V) shown in FIG. 1. Since PV-curve does not predict the impending collapse, operators relying on the PV-curve are unable to take any control actions to prevent the collapse until it is too late.

Planners and designers address this problem by setting some arbitrary voltage stability margins 108 (e.g., 5%, 10%) below which the system operation is considered to be voltage-stable. This margin 108 is set based on the past system performance and engineering judgment. Thus, the current industry approaches and tools for voltage stability assessment offer only a partial solution which is not valid under all system conditions.

Recent industry developments had concentrated on performing the same PV-curve analysis but for a large number of different scenarios, which does not contribute to obtaining additional knowledge about accurate identification of steady-state stability limits and prediction of voltage collapse.

Voltage remaining almost constant over a range of powers and uncontrollably declining as a result of a marginal increase in power (so-called “voltage collapse”) is often observed by using PV-curves and QV-curves. However, observing phase-angle (or phase-angle difference) variation with a stressing parameter, alone or combined with voltage (e.g., PV- or QV-curve) analysis, can yield improved information regarding a proximity to an onset of power system instability and/or voltage collapse.

Let us consider power flow equations that describes real and reactive power balance in the power system and constant voltage at some generator buses. Voltages and angles are state variables, while real power, reactive power or total power are stressing parameters.

We are increasing the stressing parameter, for example real power P until voltage instability. In case of voltage instability some equations for real and/or reactive power, and therefore the system of algebraic equations, become incompatible. When power flow equations become incompatible some voltages and angles (or angle differences) experience uncontrollable change at the same value of the stressing parameter P=P_{collapse}. Therefore, we can monitor voltage instability based on variation of angles (or angle differences) alone or in combination with voltage.

There are two major reasons when power flow equations become incompatible: (1) high real power transfer; and (2) deficit of reactive power to support voltage at a bus. During high real power transfer, angle difference between two buses in the power system increases. When it becomes impossible to transfer a certain amount of real power, power flow equations become incompatible. In this case, it is more effective to monitor phase angle(s) or phase angle difference.

Further, if there is deficit of reactive power, voltage decreases. If voltage decreases, real power cannot be transferred as real power transfer limit depends on voltage. In this case, it is more effective to monitor a bus with the fastest changing voltage magnitude.

Stressing can be performed with different values of a power factor. If a major component of stressing is reactive power, then it is more effective to monitor voltage. If a major component of stressing is real power, then it is more effective to monitor phase angle or phase angle difference. Since in real time environment the power factor is unknown, it is more effective to monitor both voltage and phase angle(s) or phase angle differences. A curve with a steeper slope is more effective to use for voltage stability analysis, as disclosed here.

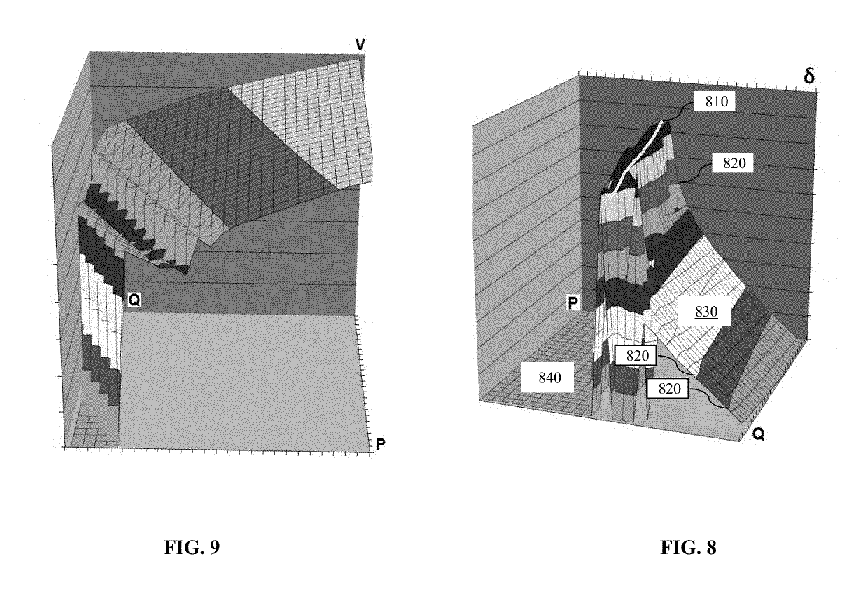

There is one more reason to monitor phase angle or phase angle difference. There are many control devices in a power system that support bus voltage, including generators and shunts. Discrete control devices that support voltage may cause “creases” visible on the V(P,Q) surface, see FIG. 9. The number of devices that control angle variation is significantly less, thus it makes angle a more effective variable to analyze voltage stability.

### III. WORKING EXAMPLES: Pδ-CURVE AND PV-CURVE ANALYSES

### Example 1.

A power flow case with the following parameters was used for computation in Example 1:

| | | | |
|---|---|---|---|
| Buses | 4911 | Generators | 454 |
| Loads | 3053 | Branches | 5072 |
| Transformers | 922 | SVDs | 670 |
| Areas | 12 | Zones | 18 |

Transfer analysis was performed as follows:
In the source subsystem, generation in control areas 4 and 8 was increased in proportion to current real power output of generators in the source.
In the sink subsystem, generation in control area 1 was decreased in proportion to current real power output of generators in the sink.
Power transfer was increased in 120 MW steps.
Voltage magnitude (V) and phase angle (δ) at bus 1899 were computed at each transfer step.
The results were plotted and are shown in FIG. 2.

The Newton method does not converge at transfer level equal to 4560 MW. PV-curve 200 and Pδ-curve 206 show that the decline in voltage and increase in absolute value of phase angle occur at the same transfer level 204. Comparing PV-curve 200 and Pδ-curve 206 in FIG. 2, we observe that voltage changes insignificantly while angle experiences significant change, giving the Pδ-curve 206 a steeper slope. Since the Pδ-curve 206 has a relatively steeper slope, it is more effective to monitor angle for voltage stability analysis.

### Example 2.

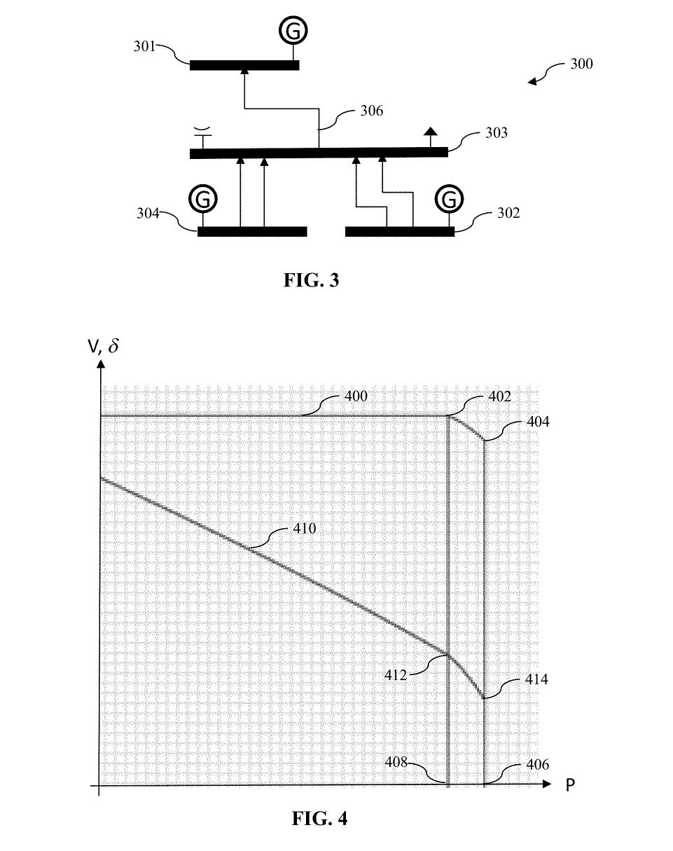

A four-bus power system 300 (FIG. 3) with the following parameters was used for computations in Example 2:

| I | NAME | BASKV | IDE | VM | VA |
|---|---|---|---|---|---|
| 1 | INF BUS | 20.0000 | 3 | 1.00000 | 0.0000 |
| 3 | Load | 20.0000 | 1 | 0.96667 | 13.7339 |
| 2 | GEN 1 | 20.0000 | 2 | 1.00000 | 17.1147 |
| 4 | GEN 2 | 20.0000 | 2 | 1.00000 | 23.8933 |

There are five generators in the system:

| I | ID | PG | QG | QT | QB | STAT | RMPCT | PT | PB |
|---|---|---|---|---|---|---|---|---|---|
| 1 | 1 | −150.000 | 33.349 | 300.000 | −300.000 | 1 | 100.00 | 600.000 | −300.000 |
| 4 | 2 | 250.000 | 66.095 | 9999.000 | −9999.000 | 1 | 100.00 | 1500.000 | 0.000 |
| 4 | 1 | 250.000 | 66.095 | 9999.000 | −9999.000 | 1 | 100.00 | 1500.000 | 0.000 |
| 2 | 2 | 25.000 | 12.856 | 1000.000 | −1000.000 | 1 | 100.00 | 100.000 | 0.000 |
| 2 | 1 | 25.000 | 12.856 | 1000.000 | −1000.000 | 1 | 100.00 | 100.000 | 0.000 |

There is one load bus:

| I | ID | STATUS | AREA | ZONE | PL | QL |
|---|---|---|---|---|---|---|
| 3 | 1 | 1 | 1 | 1 | 400.000 | 100.000 |

There is one continuous shunt in the system:

| I | MODSW | VSWHI | VSWLO | SWREM | RMPCT | RMIDNT | BINIT | N1 | B1 | N2 |
|---|---|---|---|---|---|---|---|---|---|---|
| 3 | 2 | 0.96667 | 0.96667 | 0 | 100 | | 0.00 | 1 | 600.00 | 0 |

There are five lines in the system:

| I | J | CKT | R | X | B | ST |
|---|---|---|---|---|---|---|
| 1 | 3 | 1 | 0.00000 | 0.15300 | 0.13000 | 1 |
| 3 | 4 | 1 | 0.00000 | 0.06820 | 0.10000 | 1 |
| 3 | 4 | 2 | 0.00000 | 0.06820 | 0.10000 | 1 |
| 2 | 3 | 1 | 0.00000 | 0.22800 | 0.05000 | 1 |
| 2 | 3 | 2 | 0.00000 | 0.22800 | 0.05000 | 1 |

Transfer analysis was performed as follows:
In the source subsystem, generation at buses 302 and 304 in FIG. 3 was increased in proportion to their maximum real power output in the source.
In the sink, bus 303 in FIG. 3, real component of load (P) was increased.
Power transfer was increased in 10 MW steps.
Voltage magnitude (V) at bus 303 and phase-angle difference between buses 303 and 304 were computed at each transfer step.

The Newton method does not converge at transfer level 406 equal to 1460 MW.

In this embodiment, the cause of voltage collapse is believed to be inability to transfer real power from generators connected to buses 302 and 304 to load connected to bus 303. Voltage at generator buses 302 and 304 remains constant while voltage at load bus 303 decreases since susceptance of continuous shunt at bus 303 reaches its maximum.

PV-curve 400 and Pδ-curve 410 in FIG. 4 show that the uncontrollable decline in voltage 404 and increase in absolute value of phase angle 414 occur at the same transfer level 406. Comparing PV-curve 400 and Pδ-curve 410 we observe that voltage changes insignificantly between zero and point 402. Over the same range of power, angle experiences significant change, giving the Pδ-curve a steeper slope. Since Pδ-curve has a steeper slope, it is more effective to monitor angle than voltage to assess voltage stability.

### Example 3.

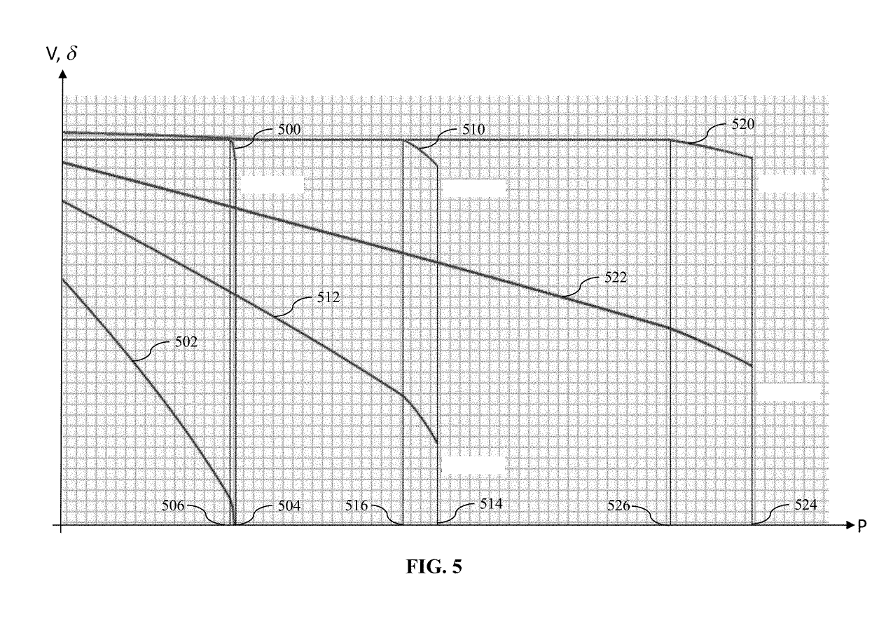

Base case value of reactance of branches 303-304 “1” and 303-304 “2” is X=0.0682 p.u. We decreased the value of reactance two times to X=0.0341 p.u. and increased it in two times to X=0.1364 p.u. The effect of changing line reactance on transfer capability is shown in FIG. 5.

Change in the value of reactance doesn't have significant effect on the slope of PV-curves 500, 510, 520. However, the length of each segment (along the P-axis) increases as reactance decreases. At the same time, the slope of δ(P)-curves 502, 512, 522 increases with reactance increase. The PV-curves 500, 510, 520 and the corresponding Pδ-curves 502, 512, 522 experience uncontrollable changes (e.g., reach a collapse point) at the same respective value 504, 514, 524 of stressing parameter, P. Comparing PV-curves 500, 510, 520 and Pδ-curves 502, 512, 522 in FIG. 5 we observe that voltage changes insignificantly while angle experiences significant change, giving the Pδ-curves a steeper slope. Since Pδ-curves have a steeper slope, it is more effective to monitor angle for voltage stability analysis. Example 4.

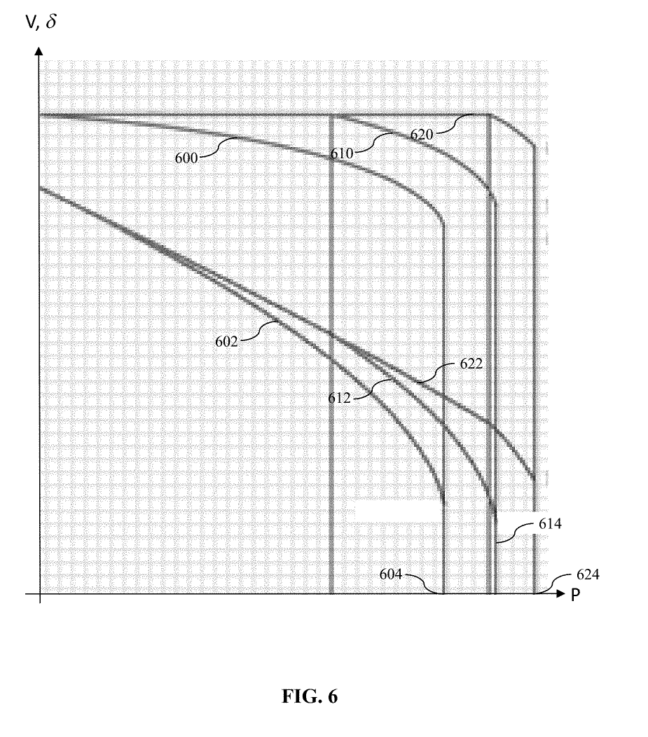

Initial shunt admittance of continuous shunt connected to bus 303 is 0 MVAr, and admittance increment B is equal to 600 MVAr. We decreased admittance increment to 300 MVAr and then to 0 MVAr. Test results are shown in FIG. 6.

Maximum transfer capability (e.g., collapse point 604, 614, 624) increases with the increase in the value of admittance. It is important to note that the PV-curves 600, 610, 620 and the corresponding Pδ-curves 602, 612, 622, respectively, experience uncontrollable change (e.g., reach collapse point) at the same value of the stressing parameter. Comparing PV-curves and Pδ-curves in FIG. 6 we observe that voltage changes insignificantly while angle experiences significant change, and Pδ-curves have a steeper slope. Since Pδ-curves have a steeper slope, it is more effective to monitor angle for voltage stability analysis.

### IV. δ(P,Q)-SURFACE AND/OR V(P,Q) ANALYSIS

As noted above, when power flow equations become incompatible, voltages experience uncontrollable decline and angles (or angle differences) experience uncontrollable change at the same value of the stressing parameter P=P_{collapse}.

Stress on a given power-system configuration can be applied with different values of power factor. If a major component of stressing is reactive power, then it can be more effective to monitor voltage. However, if a major component of stressing is real power, then it can be more effective to monitor phase angle or phase-angle differences.

In real-time environments the power factor is usually unknown. Thus, as a practical matter, it is often more effective to monitor both voltages and phase angles or (phase-angle differences). In either case, monitoring or analyzing the curve with a steeper slope can be more effective for voltage stability analysis, as steeper-slope curves can yield more information regarding available operating margin.

The disclosed method involves construction of a pair of surfaces representing voltage magnitude and phase angle as respective functions of real power and reactive power V(P,Q) and δ(P,Q). PV-curves, QV-curves, and Pδ-curves and QS-curves, discussed above, represent respective sections of surface V(P,Q) in three-dimensional V-P-Q space and surface δ(P,Q) in three-dimensional δ-P-Q space.

A given power-system configuration may be operated within a region bounded by one of a V(P,Q)-surface (e.g., as shown in FIG. 7) and a δ(P,Q)-surface (e.g., as shown in FIG. 8). The power-system configuration may be operated until the Voltage Collapse Line 710 is reached. The Voltage Collapse Line 710 is the line beyond which uncontrollable decline of voltage magnitude occurs. Alternatively, referring to FIG. 8, the power system may be operated until the Line of Uncontrollable Angle Change is reached. The Line of Uncontrollable Angle Change is the line beyond which irreversible change of phase angle occurs.

### V. WORKING EXAMPLES: δ(P,Q)-SURFACE AND/OR V(P,Q)-SURFACE ANALYSES

A power flow case with the following parameters was used for computations in the following Examples 1 through 3.

| | | | |
|---|---|---|---|
| Buses | 9013 | Transformers | 2489 |
| Loads | 7365 | Areas | 39 |
| Generators | 1693 | SVDs | 917 |
| Branches | 9861 | Zones | 97 |

Example 1.

FIG. 7 shows a three-dimensional surface V(P,Q) that represents variation of voltage magnitude (V, p.u.) as a function of real power (P, MW) and reactive power (Q, MVAr). FIG. 7 shows a weak relationship between the Voltage Collapse Line 710 and equal level lines of surface the V(P,Q), i.e. it is impossible to predict voltage collapse based on the change in voltage magnitude.

FIG. 8 shows a three-dimensional surface δ(P,Q) that represents variation of phase angle (δ, deg.) as a function of real power (P, MW) and reactive power (Q, MVAr). FIG. 8 shows that the Line of Uncontrollable Angle Change 810 is parallel to the equal level lines of phase angle 820, i.e. it is possible to predict voltage collapse based on the change in phase angle. A curve 810 depicts a boundary between a region of stability 830 in δ-P-Q space and a region of instability 840 in δ-P-Q space. Because phase-angle, δ, varies substantially throughout the region of stability 830, the δ(P,Q) surface provides information regarding proximity to the stability/instability boundary 810.

From FIG. 7 and FIG. 8 it follows that approaching voltage collapse is visible on the surface of phase angle, so the traditional PV-curves and QV-curves are practically useless.

### Example 2.

FIG. 9 shows a three-dimensional surface V(P,Q) that represents variation of voltage magnitude (V, p.u.) as a function of real power (P, MW) and reactive power (Q, MVAr). Surface level lines are not parallel to the coordinate axes, which means that performing PV-curve analysis separately from QV-curve analysis will fail to yield correct voltage stability limit. Note that the surface starts to display “creases”. “Creases” on the surface become noticeable when the upper threshold of power is reached, e.g., point 106 in FIG. 1 or point 1102 in FIG. 13. These “creases” and Voltage Collapse Line are parallel to the lines of the equal level of this surface. Instability occurs due to decrease in voltage magnitude.

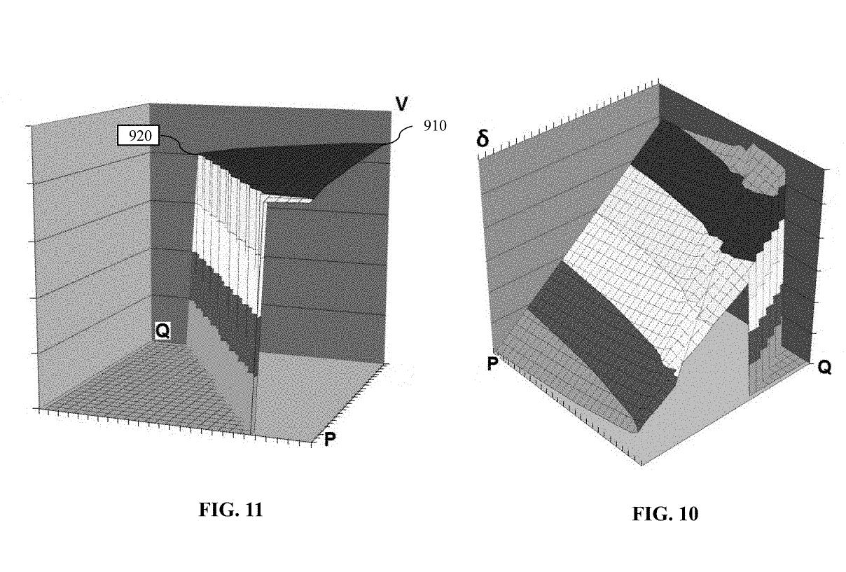

FIG. 10 shows a three-dimensional surface δ(P,Q) that represents variation of phase angle (δ, deg.) as a function of real power (P, MW) and reactive power (Q, MVAr). Surface level lines are almost perpendicular to the real power axis. The Line of Uncontrollable Angle Change goes under an angle to real power and reactive power axes, and doesn't depend on any particular value of the phase angle. Therefore, the reason of stability violation is not a change in angle, but decrease in voltage magnitude.

### Example 3.

Control devices do not operate in Example 3.

FIG. 11 shows a three-dimensional surface V(P,Q) that represents variation of voltage magnitude (V, p.u.) as a function of real power (P, MW) and reactive power (Q, MVAr). From FIG. 11 it follows that voltage magnitude changes insignificantly from 1.03 p.u., 910 to 1.00 p.u, 920 followed by an uncontrollable decline (e.g., stability violation). Therefore, monitoring voltage magnitude during system stressing is ineffective.

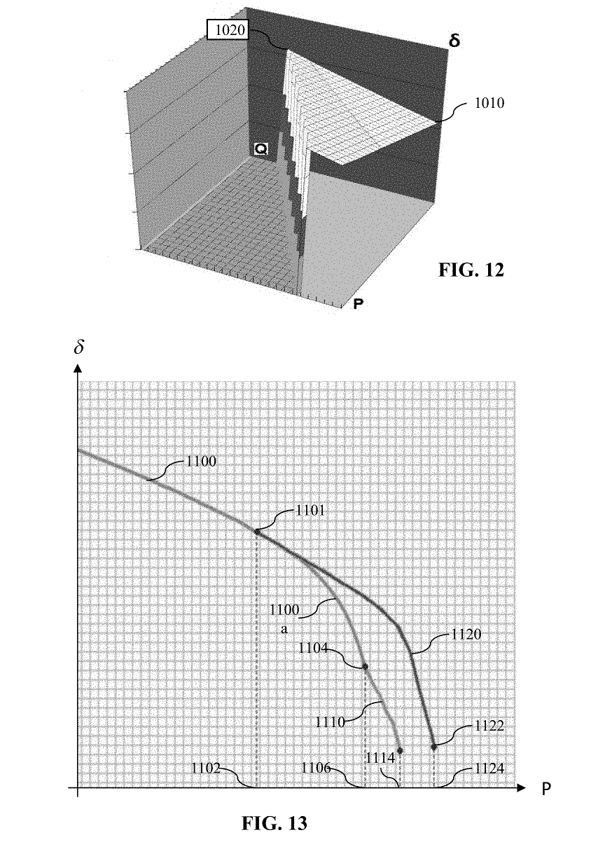

FIG. 12 shows a three-dimensional surface δ(P,Q) that represents variation of phase angle (δ, deg.) as a function of real power (P, MW) and reactive power (Q, MVAr). The absolute value of phase angle increases from 81°, 1010, to 92°, 1020. Since phase angle significantly changes, monitoring phase angle during system stressing is effective.

### VI. OBSERVATIONS

PV-curves and QV-curves are the most frequently used approaches for voltage stability analysis. However, PV-curve analysis does not yield useful results under certain conditions. For example, voltage remains almost constant followed by an uncontrollable decline. This behavior is frequently observed in systems with deficit of real power and surplus of reactive power.

It is possible to overcome these limitations of PV-curve and QV-curve analysis by incorporating phase angle variation in steady-state stability criterion for power flow equations.

As noted, when power flow equations become incompatible, voltages experience uncontrollable decline and angles (or angle differences) experience uncontrollable change at the same value of the stressing parameter P=P_{collapse}. Therefore, we can monitor voltage instability based on variation of voltages and angles (or angle differences). A curve with a steeper slope (PV or Pδ, and QV or Qδ) is generally more effective to use for voltage stability analysis. When stressing a power system with different power factors, use of a three-dimensional surface V(P,Q) or δ(P,Q) can be desirable. Since power system stressing parameters can include any combination of real and reactive power, for example, real and/or reactive components of load, generator power output, and/or power transfer through an interface, three-dimensional surfaces V(P₁,P₂) or δ(P₁,P₂) can be calculated such that P₁ is one power transfer, and P₂ is another power transfer. Variation of phase angle and voltage magnitude can be determined (e.g., calculated, inferred, or observed) for n stressing parameters (for example, power transfers) in n+1-dimensional space.

### VII. REMEDIAL ACTIONS

When identifying control actions to mitigate the onset of voltage instability, the slope of PV-curves, Pδ-curves, QV-curves and/or Qδ-curves can be considered. Additionally or alternatively, V(P,Q)-surfaces and/or δ(P,Q)-surfaces can be considered when identifying control actions to mitigate the onset of voltage instability. A curve with a steeper slope (PV or Pδ, and QV or Qδ) and/or a surface with a steeper slope (V(P,Q) or δ(P,Q)) can be used to identify voltage stability limit (or a proximity to the voltage-stability limit), and then determine control or remedial actions.

Referring to FIG. 13, identification of the value of voltage stability margin will allow power-system planners, designers, and/or operators to take one or more remedial actions before the onset of voltage collapse. During planning activities or designing activities for a contemplated power-system configuration, determining proximity to voltage collapse can involve analytical and/or numerical simulations in which a “power-system configuration” (or mathematically modeled power-system configuration) can be “operated” (or the mathematical model of the power-system configuration can be solved in context of one or more sets of boundary conditions). From such a simulation, proximity to voltage collapse can be determined by assessing from the simulation information a phase-angle and/or a voltage magnitude and identifying where within the PV-curves, Pδ-curves, QV-curves, Qδ-curves, V(P,Q)-surfaces, and/or δ(P,Q)-surfaces the system operation fell. If a simulated proximity to voltage collapse for the “power-system configuration” falls below a selected threshold proximity, the power-system configuration and/or the imposed boundary conditions can be adjusted according to one or more contemplated or proposed remedial actions. The adjusted or remediated model of the power-system can be “operated” (e.g., simulated) and proximity to voltage collapse for the adjusted or remediated power-system can be determined.

For example, simulating or analyzing one or more proposed remedial actions can provide an assessment of the effect of such adjustment to the power-system configuration or remedial action on proximity to voltage collapse for the adjusted or remediated power-system configuration. Contemplated or proposed remedial actions can include, by way of example and not limitation, adjusting the power-system configuration to change generator real-power output, adjusting the power-system configuration to change generator reactive-power output, adjusting the power-system configuration to curtail one or more loads, adjusting the power-system configuration to reposition, to include, and/or to exclude one or more capacitors, reactors, phase-shifters, transformer taps, and/or transmission lines; and adjusting the power-system configuration to implement a Remedial Action Scheme (RAS). According to the North American Electric Reliability Corporation (NERC), RAS/SPS are designed to detect predetermined System conditions and automatically take corrective actions that may include, but are not limited to, adjusting or tripping generation (MW and Mvar), tripping load, or reconfiguring a System(s).

During the design or planning stages for a given power-system configuration, such simulation and testing of various combinations of power-system configuration and remedial action can allow designers or planners to assess and select from a wide variety of configuration and remediation options. Additionally, such assessment can inform decision-making and remediation selections when operating an actual power-system configuration. For example, real-time or near real-time simulations of proposed or contemplated remediation actions using actual (e.g., then-current) power-system configurations can identify a combination of one or more remediation actions likely to mitigate or eliminate voltage collapse. Alternatively, or additionally, a store of prior simulations of power-system configurations and effects of proposed or contemplated remedial actions can be reviewed or considered during real-time operation of an actual power-system configuration. Such review or consideration of prior simulations can inform an operator's selection of one or more remedial actions should a proximity to voltage collapse fall below an acceptable threshold proximity during operation of the power-system configuration.

As disclosed more fully below and shown in FIG. 13, applying such remedial actions before a voltage collapse point, e.g., at a selected upper-threshold value of stress, can extend the range of possible stressing parameter, P, while maintaining voltage-stable operation of the power system. FIG. 13 shows the efficiency of applying remedial actions at the upper-threshold value of stress, using a Pδ-curve 1100 for increasing voltage stability margin.

The following points are shown in FIG. 13:
1106: Value of stressing parameter, P_{collapse}, at voltage collapse point 1104,
1102: Value of stressing parameter, Pₗᵢₘ, at the upper-threshold value of stress (e.g., operating voltage stability limit) 1101;
1114: Increased threshold of stressing parameter, P_{OPM1}, for voltage-stable operation if remedial actions are taken at the value of stressing parameter at the collapse point 1106;
1124: Increased threshold of stressing parameter, P_{OPM2}, for voltage-stable operation if remedial actions are taken at an upper threshold value of stressing parameter 1102 lower than the value of the stressing parameter 1106 at voltage collapse;

FIG. 13 shows a plot of Pδ-curve 1100 reflective of phase-angle variation corresponding to a stress on a given power-system configuration. The upper-threshold value of stress 1102 corresponds to an observed phase-angle 1101. The voltage collapse point 1106 corresponds to an observed phase-angle 1104.

The example in FIG. 13 illustrates the results of two tests. In the first test, one or more remedial actions are taken with regard to the power-system configuration at the value of stressing parameter at collapse point P_{collapse} 1106. As a result of those actions, the adjusted power-system configuration maintains voltage-stable operation until the value of P_{OPM1} 1114 is reached, and the Pδ-curve 1100, 1100 a extends by the segment 1110.

In the second test, remedial actions are taken at the value of stressing parameter at the upper-threshold value of stress Pₗᵢₘ, 1102 (corresponding to observed phase-angle 1101) and voltage stability margin is increased until the value of P_{OPM2} 1124 is reached, and the Pδ-curve 1100 extends by the segment 1120 to a phase-angle 1122, beyond which voltage collapses and phase-angle changes uncontrollably.

In the examples discussed, voltage stability margin is increased by 500 MW (or 100% increase) from P_{OPM1} 1114 to P_{OPM2} 1124, if remedial actions are applied at the value of stressing parameter at the upper-threshold value of stress 1102 rather than at the value of stressing parameter at the collapse point 1106. Exemplary remedial actions include by way of example and not limitation adjusting the power-system configuration to provide additional real power, adjusting the power-system configuration to provide additional reactive power, adjusting the power-system configuration to curtail one or more loads, adjusting the power-system configuration to reposition, to include, and/or to exclude one or more capacitors, reactors, phase-shifters, transformer taps, and/or transmission lines, and adjusting the power-system configuration to implement a Remedial Action Scheme.

Unlike Pδ-curve in FIG. 13, corresponding PV-curve 100 in FIG. 1 does not allow a planner, designer, and/or operator of a power system to identify the upper-threshold value of stress before that threshold is met and voltage collapses. Thus, remedial actions to increase voltage stability margin using PV-curve 100 in FIG. 1 can be applied only at the value of stressing parameter at collapse point 104, which corresponds to the value of stressing parameter at collapse point 1106 in FIG. 13, which results in increase of voltage stability margin only to P_{OPM1} 1114. Using methods disclosed herein, even higher levels of system stressing parameter can be achieved because remedial actions can be taken at lower levels 1101 of system stress.

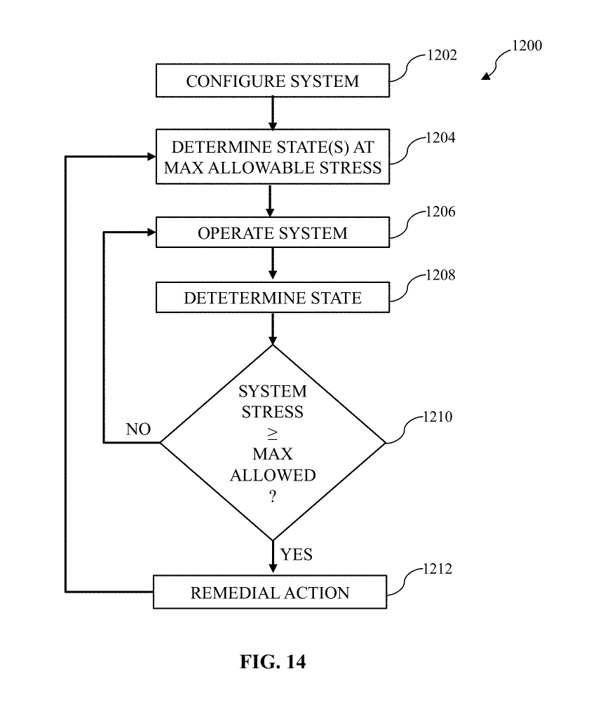

FIG. 14 illustrates an embodiment 1200 of innovative methods for designing, planning, and/or operating a voltage-stable power system configuration.

At block 1202, a power-system configuration is defined or identified.

At block 1204, one or more state variables are determined under different values of stressing parameters. As noted above, such state variables can include voltage, V, and phase-angle, δ(or phase-angle differences).

At block 1206, the power-system configuration can be operated. As used in relation to FIG. 14 and related methods, operation of a power-system configuration can refer to physical operation of a tangible, real, working power system. Alternatively, operation of a power-system configuration can refer to simulated or planned operation of a given power-system configuration.

At block 1208, one or more state variables are measured, observed, estimated, or otherwise determined. With a physically operational power-system configuration, the determining step at block 1208 can include measuring, detecting, sensing, or otherwise experimentally determining a one or more measures of an operational state of the power-system configuration. With a or simulated operation, the determining step at block 1208 can include using one or more known numerical methods to solve a large set of algebraic equations to estimate or predict one or more state variables associated with the power-system configuration arising from one or more stressing parameters applied to the power-system configuration.

At block 1210, one or more measures of system stress determined from the operation state determined at block 1208 can be compared to a selected threshold measure of system stress, e.g., voltage stability limit 1102 (FIG. 13) or voltage collapse point 1106. If the determined stress is less than the threshold measure of system stress, the method returns to block 1206, proceeds to block 1208 and back to 1210. If the determined stress equals or exceeds the threshold measure of system stress, the method proceeds to block 1212.

At block 1212, one or more remedial actions can be taken. As above, exemplary remedial actions include by way of example and not limitation adjusting the power-system configuration to provide additional real power, adjusting the power-system configuration to provide additional reactive power, adjusting the power-system configuration to curtail one or more loads, adjusting the power-system configuration to reposition, to include, and/or to exclude one or more capacitors, reactors, phase-shifters, transformer taps, and/or transmission lines, and adjusting the power-system configuration to implement a Remedial Action Scheme. Such remedial action can be taken during a planning or a design stage, and thus can result in a change to a designed power-system configuration. Alternatively, or additional, such remedial action can be taken during operation of an existing power-system configuration. Consequently, such remedial action can result in a change to a simulated power-system configuration or to a physical, tangible power-system configuration.

Following remedial actions, the method 1200 returns to block 1204, proceeds to blocks 1206, 1208, and 1210, at which point the determined system stress is again compared to the upper threshold system stress.

### IX. COMPUTING ENVIRONMENTS

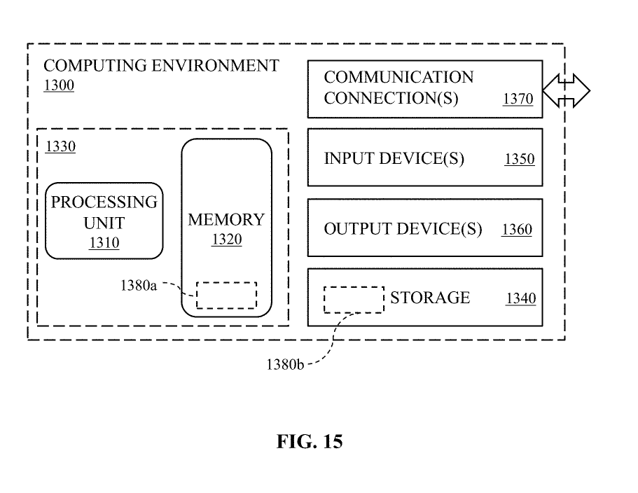

FIG. 15 illustrates a generalized example of a suitable computing environment 1300 in which described methods, embodiments, techniques, and technologies relating, for example, to power systems can be implemented. The computing environment 1300 is not intended to suggest any limitation as to scope of use or functionality of the technologies disclosed herein, as each technology may be implemented in diverse general-purpose or special-purpose computing environments. For example, each disclosed technology may be implemented with other computer system configurations, including wearable and handheld devices (e.g., a mobile-communications device, or, more particularly but not exclusively, IPHONE®/IPAD® devices, available from Apple Inc. of Cupertino, Calif.), multiprocessor systems, microprocessor-based or programmable consumer electronics, embedded platforms, network computers, minicomputers, mainframe computers, smartphones, tablet computers, data centers, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 1300 includes at least one central processing unit 1310 and memory 1320. In FIG. 15, this most basic configuration 1330 is included within a dashed line. The central processing unit 1310 executes computer-executable instructions and may be a real or a virtual processor. In a multi-processing system, multiple processing units execute computer-executable instructions to increase processing power and as such, multiple processors can run simultaneously. The memory 1320 may be volatile memory (e.g., registers, cache, RAM), non-volatile memory (e.g., ROM, EEPROM, flash memory, etc.), or some combination of the two. The memory 1320 stores software 1380a that can, for example, implement one or more of the innovative technologies described herein, when executed by a processor.

A computing environment may have additional features. For example, the computing environment 1300 includes storage 1340, one or more input devices 1350, one or more output devices 1360, and one or more communication connections 1370. An interconnection mechanism (not shown) such as a bus, a controller, or a network, interconnects the components of the computing environment 1300. Typically, operating system software (not shown) provides an operating environment for other software executing in the computing environment 1300, and coordinates activities of the components of the computing environment 1300.

The store 1340 may be removable or non-removable, and can include selected forms of machine-readable media. In general, machine-readable media includes magnetic disks, magnetic tapes or cassettes, non-volatile solid-state memory, CD-ROMs, CD-RWs, DVDs, magnetic tape, optical data storage devices, and carrier waves, or any other machine-readable medium which can be used to store information and which can be accessed within the computing environment 1300. The storage 1340 stores instructions for the software 1380, which can implement technologies described herein.

The store 1340 can also be distributed over a network so that software instructions are stored and executed in a distributed fashion. In other embodiments, some of these operations might be performed by specific hardware components that contain hardwired logic. Those operations might alternatively be performed by any combination of programmed data processing components and fixed hardwired circuit components.

The input device(s) 1350 may be a touch input device, such as a keyboard, keypad, mouse, pen, touchscreen, touch pad, or trackball, a voice input device, a scanning device, or another device, that provides input to the computing environment 1300. For audio, the input device(s) 1350 may include a microphone or other transducer (e.g., a sound card or similar device that accepts audio input in analog or digital form), or a computer-readable media reader that provides audio samples to the computing environment 1300.

The output device(s) 1360 may be a display, printer, speaker transducer, DVD-writer, or another device that provides output from the computing environment 1300.

The communication connection(s) 1370 enable communication over a communication medium (e.g., a connecting network) to another computing entity. The communication medium conveys information such as computer-executable instructions, compressed graphics information, processed signal information (including processed audio signals), or other data in a modulated data signal.

Thus, disclosed computing environments are suitable for transforming a signal corrected as disclosed herein into a human-perceivable form. As well, or alternatively, disclosed computing environments are suitable for transforming a signal corrected as disclosed herein into a modulated signal and conveying the modulated signal over a communication connection.

Machine-readable media are any available media that can be accessed within a computing environment 1300. By way of example, and not limitation, with the computing environment 1300, machine-readable media include memory 1320, storage 1340, communication media (not shown), and combinations of any of the above. Tangible machine-readable (or computer-readable) media exclude transitory signals.

### X. OTHER EMBODIMENTS

The examples described above generally concern apparatus, methods, and related systems for maintaining voltage-stable operation of power-system configurations, and more particularly but not exclusively to using phase-angle alone or in combination with voltage magnitude as an indicium of power-system stress and/or voltage stability. Nonetheless, embodiments other than those described above in detail are contemplated based on the principles disclosed herein, together with any attendant changes in configurations of the respective apparatus described herein.

Other aspects of methods for providing a voltage-stable power system are disclosed. Correspondence between a phase-angle representative of an operational state of a power-system configuration and a proximity to voltage-collapse for the power-system configuration can be provided. A proximity to voltage-collapse can be determined for the power-system configuration based at least in part on an observation of the phase-angle and the correspondence between the phase-angle and the proximity to voltage-collapse for the power-system configuration. Responsive to the proximity to voltage-collapse for the power-system configuration falling below a selected threshold proximity, a remedial action contemplated to maintain voltage-stable operation of the power-system configuration can be taken. For example, an alarm can be initiated. The power-system configuration can be adjusted to change generator real-power output and/or generator reactive-power output, to curtail one or more loads, to reposition, include, and/or exclude one or more capacitors, reactors, phase-shifters, transformer taps, and/or transmission lines, and/or to implement a Remedial Action Scheme.

Phase-angle variation with real power at one or more values of reactive power, phase-angle variation with reactive power at one or more values of real power, or both, can be provided. Phase-angle variation with real power and reactive power in a three-dimensional space can be provided.

In some embodiments, a correspondence between voltage magnitude representative of an operational state of the power-system configuration and a proximity to voltage collapse can also be provided. In such embodiments, proximity to voltage collapse can be determined based further on an observation of voltage magnitude and the correspondence between the voltage magnitude and proximity to voltage collapse. For example, which of voltage-magnitude variation with real power and phase-angle variation with real power has a steeper slope can be determined.

In some instances, voltage-magnitude variation with real power at one or more values of reactive power, voltage-magnitude variation with reactive power at one or more values of real power, or both, can be provided. Determining a proximity to voltage collapse based at least in part on an observation of voltage magnitude can occur concurrently with the act of determining a proximity to voltage collapse based at least in part on an observation of phase-angle.

In some instances where a remedial action includes adjusting the power-system configuration, correspondence between a phase-angle representative of an operational state of the adjusted power-system configuration and a proximity to voltage collapse for the adjusted power-system configuration can be provided. A proximity to voltage collapse for the adjusted power-system configuration can be determined based at least in part on an observation of the phase-angle and the provided correspondence between the phase-angle and the proximity to voltage collapse for the adjusted power-system configuration. A second remedial action contemplated to maintain voltage-stable operation of the adjusted power-system configuration can be taken responsive to the proximity to voltage collapse for the adjusted power-system configuration falling below a selected second threshold proximity.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.”

The principles described above in connection with any particular example can be combined with the principles described in connection with another example described herein. Accordingly, this detailed description shall not be construed in a limiting sense, and following a review of this disclosure, those of ordinary skill in the art will appreciate the wide variety of embodiments that can be devised using the various concepts described herein.

Moreover, those of ordinary skill in the art will appreciate that the exemplary embodiments disclosed herein can be adapted to various configurations and/or uses without departing from the disclosed principles. Applying the principles disclosed herein, it is possible to provide a wide variety of systems adapted to maintain voltage-stable operation of power systems. For example, modules identified as constituting a portion of a given computational engine in the above description or in the drawings can be omitted altogether or implemented as a portion of a different computational engine without departing from some disclosed principles. Moreover, each method act carried out by one or more such modules can be combined with one or more other method acts carried by the respective module (or another module) to achieve a desired outcome. Every such combination and permutation of method acts are contemplated by, and fall within the scope of, this disclosure, despite that each such combination and permutation is not described in detail herein in the interest of brevity and economy.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the features and method acts of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or “step for”.

Thus, in view of the many possible embodiments to which the disclosed principles can be applied, we reserve to the right to claim any and all combinations of features and technologies described herein as understood by a person of ordinary skill in the art, including, for example, all that comes within the scope and spirit of the following claims.

Listing of claims:

1. A method for providing a voltage-stable power system, the method comprising:
for a power-system configuration, providing correspondence of a proximity to voltage collapse with a measure of phase-angle representative of a selected measure of stress applied to the power-system configuration, wherein voltage collapses and phase-angle uncontrollably changes at a same threshold value of the selected measure of stress applied to the power-system configuration;
determining a proximity to voltage-collapse for the power-system configuration based at least in part on an observation of the phase-angle and the correspondence between the phase-angle and the proximity to voltage-collapse; and
responsive to the proximity to voltage-collapse for the power-system configuration falling below a selected threshold proximity, taking a remedial action contemplated to maintain voltage-stable operation of the power-system configuration.

2. The method according to claim 1, wherein the act of taking a remedial action contemplated to maintain voltage-stable operation of the power-system configuration comprises one or more of the following:
adjusting the power-system configuration to change generator real-power output;
adjusting the power-system configuration to change generator reactive-power output;
adjusting the power-system configuration to curtail one or more loads;
adjusting the power-system configuration to reposition, to include, and/or to exclude one or more capacitors, reactors, phase-shifters, transformer taps, and/or transmission lines; and
adjusting the power-system configuration to implement a Remedial Action Scheme.

3. The method according to claim 1, wherein the act of providing correspondence between the phase-angle representative of the selected measure of stress and the proximity of voltage-collapse for the power-system configuration comprises providing phase-angle variation with real power at one or more values of reactive power, providing phase-angle variation with reactive power at one or more values of real power, or both.

4. The method according to claim 1, wherein the act of providing correspondence between the phase-angle representative of the selected measure of stress and the proximity to voltage collapse for the power-system configuration comprises providing phase-angle variation with real power and reactive power in a three-dimensional space.

5. The method according to claim 1, further comprising providing a correspondence between voltage magnitude representative of the selected measure of stress applied to the power-system configuration and a proximity to voltage collapse, wherein the act of determining a proximity to voltage collapse is further based at least in part on an observation of voltage magnitude and the correspondence between the voltage magnitude and proximity to voltage collapse.

6. The method according to claim 5, wherein the act of determining a proximity to voltage collapse comprises determining which of voltage-magnitude variation with real power and phase-angle variation with real power has a steeper slope.

7. The method according to claim 5, wherein the act of providing correspondence between the voltage magnitude representative the selected measure of stress and the proximity of voltage-collapse for the power-system configuration comprises providing voltage-magnitude variation with real power at one or more values of reactive power, providing voltage-magnitude variation with reactive power at one or more values of real power, or both.

8. The method according to claim 7, wherein the act of determining a proximity to voltage collapse based at least in part on an observation of voltage magnitude occurs concurrently with the act of determining a proximity to voltage collapse based at least in part on an observation of phase-angle.

9. The method according to claim 5, wherein the act of providing correspondence between the voltage magnitude representative of the selected measure of stress and the proximity to voltage collapse for the power-system configuration comprises determining voltage-magnitude variation with real power and reactive power in a three-dimensional space.

10. The method according to claim 9, wherein the act of providing correspondence between the phase-angle representative of the selected measure of stress and the proximity to voltage collapse for the power-system configuration comprises providing phase-angle variation with real power and reactive power in a three-dimensional space.

11. The method according to claim 10, wherein the act of determining a proximity to voltage collapse based at least in part on an observation of voltage magnitude occurs concurrently with the act of determining a proximity to voltage collapse based at least in part on an observation of phase-angle.

12. The method according to claim 1, wherein the act of taking a remedial action comprises adjusting the power-system configuration, the method further comprising providing correspondence between a phase-angle representative of the selected measure of stress applied to the adjusted power-system configuration and a proximity to voltage collapse for the adjusted power-system configuration.

13. The method according to claim 12, further comprising determining a proximity to voltage collapse for the adjusted power-system configuration based at least in part on an observation of the phase-angle and the provided correspondence between the phase-angle and the proximity to voltage collapse for the adjusted power-system configuration.

14. The method according to claim 13, wherein the selected threshold proximity comprises a first threshold proximity and the remedial action comprises a first remedial action, the method further comprising taking a second remedial action contemplated to maintain voltage-stable operation of the adjusted power-system configuration responsive to the proximity to voltage collapse for the adjusted power-system configuration falling below a selected second threshold proximity.

15. A tangible, non-transitory, machine readable medium containing machine-executable instructions that, when executed, cause a computing environment to perform a method comprising:
for a power-system configuration, providing correspondence of a proximity to voltage collapse with a measure of phase-angle representative of the selected measure of stress applied to the power-system configuration, wherein voltage collapses and phase-angle uncontrollably changes at a same threshold value of the selected measure of stress applied to the power-system configuration;
determining a proximity to voltage-collapse for the power-system configuration based at least in part on an observation of the phase-angle and the correspondence between the phase-angle and the proximity to voltage-collapse; and
responsive to the proximity to voltage-collapse for the power-system configuration falling below a selected threshold proximity, taking a remedial action contemplated to maintain voltage-stable operation of the power-system configuration.

16. The tangible, non-transitory, machine readable medium according to claim 15, wherein the act of taking a remedial action contemplated to maintain voltage-stable operation of the power-system configuration comprises one or more of the following:
adjusting the power-system configuration to change generator real-power output;
adjusting the power-system configuration to change generator reactive-power output;
adjusting the power-system configuration to curtail one or more loads;
adjusting the power-system configuration to reposition, to include, and/or to exclude one or more capacitors, reactors, phase-shifters, transformer taps, and/or transmission lines; and
adjusting the power-system configuration to implement a Remedial Action Scheme.

17. The tangible, non-transitory, machine readable medium according to claim 15, wherein the act of providing correspondence between the phase-angle representative of the selected measure of stress applied to the power-system configuration and the proximity of voltage-collapse for the power-system configuration comprises providing phase-angle variation with real power at one or more values of reactive power, providing phase-angle variation with reactive power at one or more values of real power, or both.

18. The tangible, non-transitory, machine readable medium according to claim 15, wherein the act of providing correspondence between the phase-angle representative of the selected measure of stress applied to the power-system configuration and the proximity to voltage collapse for the power-system configuration comprises providing phase-angle variation with real power and reactive power in a three-dimensional space.

19. The tangible, non-transitory, machine readable medium according to claim 15, further comprising providing a correspondence between voltage magnitude representative of the selected measure of stress applied the power-system configuration and a proximity to voltage collapse, wherein the act of determining a proximity to voltage collapse is further based at least in part on an observation of voltage magnitude and the correspondence between the voltage magnitude and proximity to voltage collapse.

20. The tangible, non-transitory, machine readable medium according to claim 19, wherein the act of determining a proximity to voltage collapse comprises determining which of voltage-magnitude variation with real power and phase-angle variation with real power has a steeper slope.

21. The tangible, non-transitory, machine readable medium according to claim 19, wherein
the act of providing correspondence between the voltage magnitude representative of the selected measure of stress applied to the power-system configuration and the proximity of voltage-collapse for the power-system configuration comprises providing voltage-magnitude variation with real power at one or more values of reactive power, providing voltage-magnitude variation with reactive power at one or more values of real power, or both.

22. The tangible, non-transitory, machine readable medium according to claim 21, wherein the act of determining a proximity to voltage collapse based at least in part on an observation of voltage magnitude occurs concurrently with the act of determining a proximity to voltage collapse based at least in part on an observation of phase-angle.

23. The tangible, non-transitory, machine readable medium according to claim 21, wherein the act of providing correspondence between the voltage magnitude representative of a selected measure of stress applied to the power-system configuration and the proximity to voltage collapse for the power-system configuration comprises determining voltage-magnitude variation with real power and reactive power in a three-dimensional space.

24. The tangible, non-transitory, machine readable medium according to claim 23, wherein the act of providing correspondence between the phase-angle representative of a selected measure of stress applied to the power-system configuration and the proximity to voltage collapse for the power-system configuration comprises providing phase-angle variation with real power and reactive power in a three-dimensional space.

25. The tangible, non-transitory, machine readable medium according to claim 24, wherein the act of determining a proximity to voltage collapse based at least in part on an observation of voltage magnitude occurs concurrently with the act of determining a proximity to voltage collapse based at least in part on an observation of phase-angle.

26. The tangible, non-transitory, machine readable medium according to claim 15, wherein the act of taking a remedial action comprises adjusting the power-system configuration, the method further comprising providing correspondence between a phase-angle representative of a selected measure of stress applied to the adjusted power-system configuration and a proximity to voltage collapse for the adjusted power-system configuration.

27. The tangible, non-transitory, machine readable medium according to claim 26, further comprising determining a proximity to voltage collapse for the adjusted power-system configuration based at least in part on an observation of the phase-angle and the provided correspondence between the phase-angle and the proximity to voltage collapse for the adjusted power-system configuration.

28. The tangible, non-transitory, machine readable medium according to claim 27, wherein the selected threshold proximity comprises a first threshold proximity and the remedial action comprises a first remedial action, the method further comprising taking a second remedial action contemplated to maintain voltage-stable operation of the adjusted power-system configuration responsive to the proximity to voltage collapse for the adjusted power-system configuration falling below a selected second threshold proximity.

29. A method for providing a voltage-stable power system, the method comprising:
for a power-system configuration, providing correspondence between a phase-angle representative of an operational state of the power-system configuration and a proximity to voltage-collapse for the power-system configuration;
determining a proximity to voltage-collapse for the power-system configuration based at least in part on an observation of the phase-angle and the correspondence between the phase-angle and the proximity to voltage-collapse for the power-system configuration; and
responsive to the proximity to voltage-collapse for the power-system configuration falling below a selected threshold proximity, taking a remedial action contemplated to maintain voltage-stable operation of the power-system configuration.
